(19) United States
(12) Patent Application Publication
(10) Pub. No.: US 2003/0111525 A1
(43) Pub. Date: Jun. 19, 2003

(54) Method and system of determining status of automobile undergoing repair

(76) Inventors: Georgina Sweeney, Westlake, OH (US); Gueary Preston, Medina, OH (US)

Correspondence Address: PPG INDUSTRIES, INC., Intellectual Property Department, One PPG Place, Pittsburgh, PA, 15272, US

(21) Appl. No.: 10/023,678

(22) Filed: Dec. 18, 2001

(51) Int. Cl. G06F 7/00

(52) U.S. Cl. 235/376

(57) ABSTRACT

A method of determining the status of a vehicle undergoing autobody repair having the steps of: (1) electronically transferring data on the status of a vehicle being repaired to a computer database, (2) searching the database for the vehicle, (3) identifying data on the status of the vehicle, and (4) transferring the status data of step (3) to a remote location. A system for practicing this method includes one or more repair shops in communication with a plurality of vehicle owners via an autobody repair Internet website. Each repair shop maintains a computer into which data on the status of vehicles being repaired are transferred via a portable data transfer device. Vehicle owners may access the status of their vehicles being repaired via the website.

### BACKGROUND OF THE INVENTION

1. Field of the Invention

The present invention relates to a method of determining the status of a vehicle undergoing repair and to a system therefor, more particularly, a method of and a system for accessing information on the status of a vehicle undergoing repair at a remote location.

2. Prior Art

Autobody repair typically is performed in an autobody repair shop that may be an independent operator, a franchise repair shop, or a division of an automobile dealership. When a vehicle's body is damaged, the owner brings the vehicle to the shop to receive an estimate for repair of a vehicle's apparent damage. Personnel at the autobody shop prepare an estimate based on the damage that is visible to the exterior of the vehicle. Upon authorization by the owner and, where applicable, insurance approval is gained for performing the work, the repair shop begins the repair process. Many consumers are inconvenienced by the temporary loss of their vehicles undergoing repair and need to make alternative plans for transportation, hence, consumers need to know when the repair work on their vehicles will be completed. A repair shop normally provides an estimated completion date to the owner of the vehicle at the time the initial damage estimate is prepared. However, many times, the estimated completion date needs to be adjusted due to additional damage that is identified when the vehicle is dismantled or when there is a delay in obtaining parts for the vehicle. Repair shops are generally not equipped to contact the vehicle owner to inform the owner that delays are being experienced in the repair of the vehicle, and the owner is unaware of the status of the vehicle during the time in which it is undergoing repair in the shop. This lack of communication between the repair shop and the vehicle owner can lead to dissatisfaction with the repair shop by the vehicle owner.

Accordingly, improved communications between the repair shop and vehicle owner to enhance customer satisfaction are desired.

### SUMMARY OF THE INVENTION

This need is met by the method and system of the present invention of determining the status of an article on which work is being performed having the steps of: (1) electronically transferring data on the status of an article to the database of a computer, (2) searching the computer database for the article, and (3) identifying data on the status of the article. The method is particularly suited for determining the status of a vehicle undergoing repair in an autobody repair shop. Using a computer network, the status of the vehicle may be requested electronically prior to step (2), and step (3) is preferably performed electronically. The database includes an identifier for each vehicle, such as a repair order number, a Vehicle Identification Number or a bar code. Step (1) may be performed by entering the status data on the vehicles into a portable data transfer device and transferring the status data from the portable device to the computer or by entering the status data directly into the computer.

The status data includes information, such as (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed. The vehicle may undergo all or some repair steps that result in the status data of the information of (i)-(xx), preferably in the order listed. The status of the vehicle is provided to the owner of the vehicle following at least one of repair steps (v), (x), (xv), and (xx) and may be automatically provided to the owner of the vehicle.

A system of the present invention for determining the status of an article on which work is being performed, such as a vehicle undergoing autobody repair, includes a data transfer device for entering data on the status of an article on which work is being performed, a computer database for tabulating data entered in the data transfer device and transferred to the computer database; software for identifying an article in the database and the corresponding data on the status of the article; and means for transferring the corresponding data to a remote location. The means for transferring the corresponding data may be a computer network.

The system may also be used to track the repair process of a vehicle that is in a repair shop. A method of the present invention of tracking a repair process includes the steps of: periodically electronically transferring data on the status of a plurality of vehicles undergoing repair to a computer database; determining the length of time that the status data for each vehicle remains unchanged; and identifying a vehicle for which the status data is unchanged beyond a predetermined length of time. Preferably, the status data is transferred daily from a portable data transfer device to a computer.

A complete understanding of the invention will be obtained from the following description when taken in connection with the accompanying drawing figures wherein like reference characters identify like parts throughout.

### BRIEF DESCRIPTION OF THE DRAWINGS

FIG. 1 is a schematic of a system of the present invention for determining the status of a vehicle undergoing autobody repair;

FIG. 2 is a flow chart of a method of using the system shown in FIG. 1; and

FIG. 3 is a flow chart of an autobody repair process suitable for use in the present invention.

### DESCRIPTION OF THE PREFERRED EMBODIMENTS

The present invention includes a system and method for determining the status of a vehicle undergoing repair. Although the present invention is described in relationship to the status of a vehicle undergoing repair in an autobody repair shop, this is not meant to be limiting. The present invention is equally applicable to other industries in which a customer's product undergoes a lengthy manufacturing or repair process, such as custom manufacturing (e.g., home construction) or appliance repair.

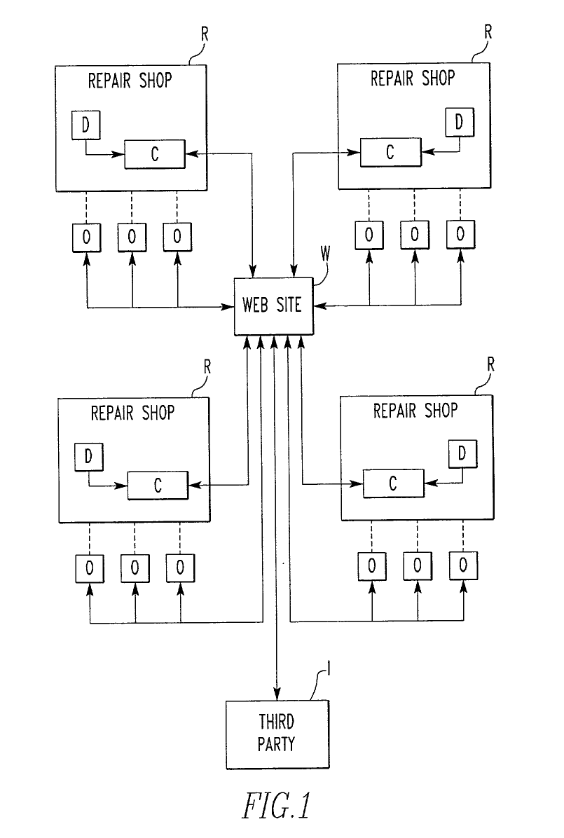

FIG. 1 schematically shows a system S of the present invention having a plurality of repair shops R in communication with a plurality of vehicle owners O via a global computer communications network, e.g., the Internet. Owner is used generically to indicate the submitter of the article to be repaired and includes the titleholder, the lessee, or other individual who has submitted the vehicle for repair. An autobody repair Internet website W on the Internet provides a communication link between the repair shops R and the vehicle owners O. Website W preferably is maintained by an industry representative of automotive repair shops. Each repair shop R preferably maintains a computer C into which data on the status of vehicles being repaired are transferred, preferably via a portable data transfer device D. Alternatively, the status data may be entered directly into the computer C without using a data transfer device D. Each vehicle in the shop R has a unique identifier by which the vehicle is tracked and identified in the system S. The identifier may be a repair order number for the repair work assigned by the repair shop R, the Vehicle Identification Number (VIN) for the vehicle, bar code, or some other identifier selected by the repair shop R. The vehicle identifier preferably also includes the make, model, color, and/or production year of the vehicle. A third party I, such as an insurance company or vehicle rental company may also be in communication with the website W.

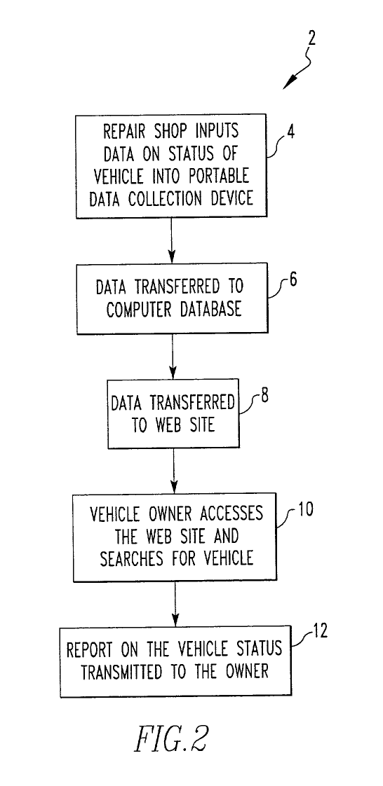

The flow chart 2 in FIG. 2 presents the basic steps of a method of using the system S of the present invention. In step 4, data on the status of a vehicle undergoing autobody repair is input into a portable data transfer device D or directly into a database on the computer C or onto the website W. When a vehicle is initially logged onto the database of the computer C or website W, general information is input such as a repair order number, (or other identifier) vehicle model, vehicle color, vehicle year, estimated delivery data and the e-mail address of the vehicle owner. A particularly suitable portable data transfer device D for inputting data on the status of a vehicle is a hand-held data transfer device, such as a Palm Pilot®. Preferably, step 4 is performed on a periodic basis, such as on each day that the repair shop R is open. Personnel of the repair shop R collect data on the repair status of each vehicle in the repair shop R, preferably at the beginning of each workday. The practice of checking the status of vehicles in a repair shop each morning the shop is open is consistent with current repair shop operations.

The portable data transfer device D preferably includes a plurality of pull-down menus containing a list of status indicators. An operator of the repair shop R determines the status of a vehicle in the shop R, enters the vehicle identifier in the portable data transfer device D for that vehicle and selects one of a plurality of predefined status indicators in the menus of the portable data transfer device D which reflects the current status of the vehicle. By selecting one of a set of predefined status indicators (e.g., in the form of menu options), the status of vehicles in the repair shop R is consistently inputted into the portable data transfer device D. For example, every vehicle in the repair shop R that is awaiting receipt of parts to continue the repair has an identical status indicator of “PARTS ORDERED”. This process is repeated for each vehicle in the shop R. The repair shop operator moves through the repair shop R and inputs the data on the status of each vehicle in the repair shop R into the portable data transfer device D. In step 6, the portable data transfer device D is transported to another location in the repair shop R for transferring the data inputted therein to a database in computer C, which preferably is a personal computer located within the repair shop R. Software on the computer C provides a mechanism for accessing the data in the portable data transfer device D and transferring the data to the database in computer C. In step 8, the data transferred and stored in the database in computer C located in the repair shop is then electronically transferred to a computer database accessible via website W. A handheld device allows the repair shop R to quickly and efficiently update the status of each vehicle and transfer that data to the website W. However, this is not meant to be limiting. For example, the repair shop R may enter the data onto a computer C in the repair shop R and transfer that data to the website W. Alternatively, the data may be entered directly onto the website W. The repair shop R may access the website W via a suitable communications device, e.g., a computer terminal with a modem. The pull down menus on the handheld device described above may appear when the repair shop R logs onto the website W. It may be desirable that each repair shop R has access only to the data on vehicles of that repair shop R via a password protection system or the like on the website W.

In step 10, the owner O of a vehicle undergoing repair at a repair shop R may access the second computer database of the autobody repair website W to check the status of its vehicle. The owner O enters the website W and searches for its vehicle in the second computer database according to the vehicle identifier. In step 12, the website W responds with a report on the status of the repair of the vehicle based on the status indicator last transmitted to the website W by the repair shop R. The report may indicate the date of transmission of the status indicator and other information concerning the repair shop R. Preferably, the data for each vehicle posted on the website W is password protected to limit a vehicle owner's access to only the data for its vehicle.

Other communication links in the system S may exist, such as between the third party I, such as an insurance company or vehicle rental company, and the website W. Insurance companies have an interest in the status of insured vehicles undergoing repair for monitoring the ongoing repair of insured vehicles, predicting when insurance payments will need to be made upon completion of the repair work or assessing the performance of repair shops R. Vehicle rental companies have an interest in the status of insured vehicles undergoing repair for monitoring the ongoing repair of insured vehicles and predicting when rental vehicles will need to be delivered and picked up. The repair shops R typically are also in contact with the vehicle's owner via more traditional mechanisms, such as the mail or telephone as indicated by the broken lines in FIG. 1.

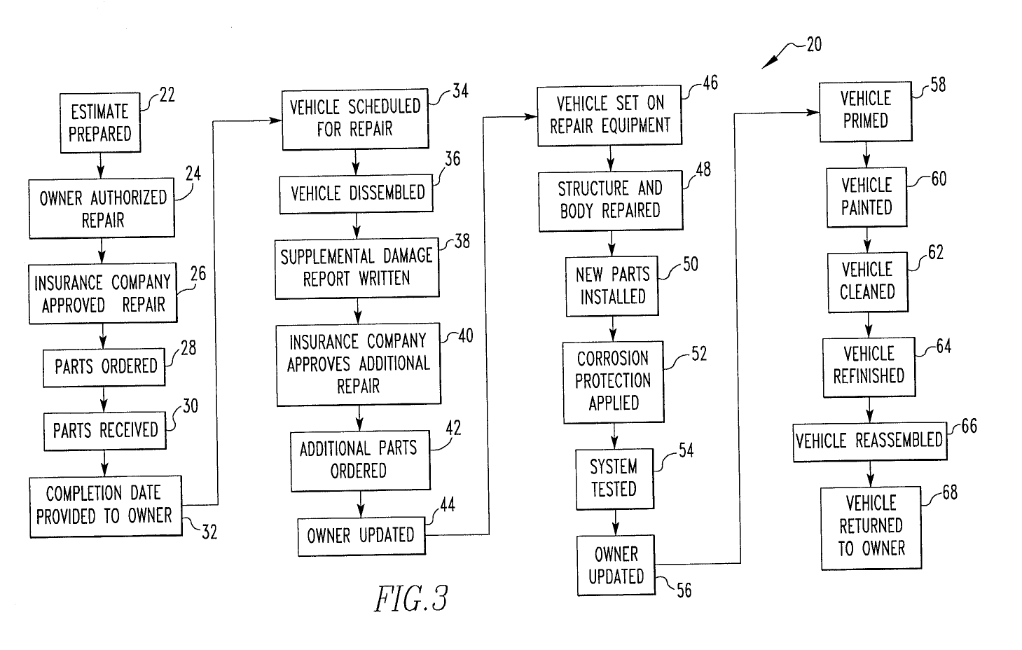

Examples of status indictors of a vehicle undergoing repair include the following: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed. Each of the status indictors corresponds to complete a step in the repair process. A repair process having steps which correspond to status indicators (i)-(xx) is shown in flowchart 20 of FIG. 3. The present invention is not intended to be limited to the particular steps set forth in FIG. 3. The repair process followed by an autobody repair shop R may be broken down into the discrete steps shown in FIG. 3, but these steps are intended to be exemplary. Not all the steps shown in FIG. 3 would be needed for all autobody repairs. Certain steps may be skipped.

In step 22, an estimate of the cost to repair the damage to a vehicle is prepared. An estimator inspects the vehicle and documents the damage caused by a collision in the form of an estimate. In certain instances, a vehicle owner may already have an estimate of the damage prepared by an insurance company. The estimate of the insurance company may be used to prepare the estimate in the repair process of the present invention. The owner of the vehicle authorizes the repair work in step 24. Before repair work begins, the vehicle owner generally signs a repair authorization allowing the repair shop to begin the work. This step confirms that both the vehicle owner and the repair shop understand the scope of the work to be performed. In step 26, for repair work that is to be paid for by an insurance company, the insurance company that is involved approves the repair estimate before the work begins by the repair shop. Parts to complete the repair are ordered in step 28. Upon receiving the approvals from the insurance company (if applicable), the repair shop begins the process of locating and ordering the parts necessary to repair the vehicle. Preferably, the parts are ordered electronically. In step 30, the parts are received. Once all the parts are received and accounted for, the repair shop can schedule the vehicle for repair. Preferably, at this stage, the vehicle owner is provided with an estimated completion date in step 32. The estimated completion date may be sent to the vehicle owner electronically, such as via e-mail using the system S, or via more traditional routes, such as by facsimile, telephone, or mail. Preferably, the website W automatically generates and sends an e-mail to the owner O when step 30 is completed. The website W may also include a mechanism for allowing a repair shop R to send updates or other comments about the status of a vehicle to its owner O by e-mail. The website W may generate standardized e-mail messages that the repair shop R may choose to send, or the repair shop R may write a customized e-mail message.

In step 34, the vehicle is scheduled for the necessary repairs. If the vehicle is in the possession of the owner O, the owner O is contacted to schedule a convenient time for the vehicle to be repaired by the repair shop R. Again, the owner may be automatically notified of the need to schedule the repair by an e-mail generated from the website W. The vehicle is dissembled in step 36. The outer panels of the vehicle are typically removed and the physical structure of the vehicle is revealed. Frequently, additional or “hidden damage” is discovered when the outer panels are removed. The vehicle is reinspected to check for such additional damage that might have been otherwise difficult to diagnose during the original estimate if it could not be seen or predicted. A supplemental damage report is written in step 38 to cover any additional or hidden damage that is discovered once the outer panels are removed and the physical structure of the vehicle is revealed. If applicable, the insurance company approves additional repair to correct the additional damage in step 40. Any necessary additional parts are ordered in step 42. If additional damage is located in step 36, steps 28, 30, and 32 are repeated to obtain the necessary parts to complete the repair. At this stage, the vehicle owner O is again contacted in step 44 to be updated on the progress of the vehicle repair. Contact of the owner O may be electronic and automatic or be accomplished via conventional routes as described in step 32.

If necessary, the vehicle is set on repair equipment in step 46 to ensure that the location and fit of integral parts of the vehicle that are critical to the operation and appearance of the vehicle are in compliance with the structural standards of the vehicle manufacturer. In step 48, the structural and body repairs are completed. New panels are installed and checked for proper fit in step 50. Generally, collision repairs require some degree of cosmetic repair and often require replacement of factory panels. Proper fit of the panels and the appearance of the vehicle's components, their fit, and alignment are all checked.

Most vehicles incorporate some form of corrosion protection that is applied by the original manufacturer. This corrosion protection is reapplied in step 52 by the repair shop R to ensure that the vehicle conforms to the original manufacturer's standards. At the stage of step 54, repair work of the metal is completed and initial tests are performed to check for proper functioning and to perform quality control of the repair work. Safety systems, such as passenger restraints or air bag systems, are checked in this step. Following step 54, the customer is again preferably updated in step 56 on the status of the repair of the vehicle either electronically or conventionally as described in step 32.

In steps 58-64, the vehicle is refinished. The initial step in refinishing the surface of the vehicle (step 58) is to apply a primer. A surface filler is sprayed to ensure quality uniformly smooth surface and block sanding may be performed to further prepare the surface for paint. In step 60, the vehicle is painted. The vehicle may be placed in a paint booth and, preferably, is masked to protect the vehicle from overspray during the painting step. The vehicle is cleaned in step 62 and all objects and contaminants that may have been deposited on the vehicle during the repair process are removed. Any dust particles that may remain are also removed. In step 64, the vehicle is refinished. Most vehicles are coated with a refinish including a base coat and clear coat. Occasionally, a single coat system is used. In either case, refinishing involves application of several coatings to ensure a quality finish. Finally, the vehicle is reassembled in step 66. The outer components, such as mirrors, moldings, and other hardware, are reattached to the vehicle. Any wheel alignment or other services, such as air conditioning repair, can be performed at this time. At this stage, the vehicle is ready for return to the owner O in step 68. The owner is contacted in step 68 as described above in step 32.

The present invention also includes a method of tracking how certain vehicles progress through a repair process, such as the process set forth in FIG. 3 by using the data transfer device D and computer C of a repair shop R. The length of time (e.g., the number of days) that a vehicle remains at each repair step, of steps 22-66, is determined by an algorithm in software in the repair shop computer C. The software identifies vehicles that remain in one or more of steps 22-66 longer than a predetermined time and outputs information indicating the vehicles for which the status data is unchanged beyond a predetermined length of time and the unchanged status data for those vehicles. The software may sort the vehicles which remain in a step for longer than a predetermined time by identifiers of make, model, year, or the like. The extent that the status data remains unchanged beyond a predetermined length of time may be determined for each identifier. In this manner, it is possible to identify classes of vehicles which remain in a repair step for longer than the predetermined length of time and, hence, may be difficult to repair and for which the repair cost therefor is higher. The software may also include an algorithm for reporting which of steps 22-66 takes the longest time and is a bottleneck in the repair process thus indicating opportunities for improving the efficiency of the repair process.

The present invention provides several benefits to a repair shop including (i) reducing the time a repair shop spends updating its customers with the status of the vehicles, by allowing customers to check the status on-line, (ii) simplifying repair tracking, by generating a report with a step-by-step history of the repair of each vehicle, and (iii) keeping customers up-to-date and informed on the repair of their vehicles. Vehicle owners are benefited by the present invention by having ready access to information on the status of their vehicles and enhanced ability to plan for alternative transportation while their vehicles are repaired.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

What is claimed is:

1. A method of determining the status of an article on which work is being performed comprising the steps of:
(1) electronically transferring data on the status of an article to a computer database;
(2) searching the computer database to locate the article; and
(3) identifying data on the status of the article.

2. The method of claim 1, wherein the article is a vehicle undergoing repair.

3. The method of claim 2, wherein step (4) comprises electronically transferring the identified data to a remote location.

4. The method of claim 3 further comprising electronically requesting the status of the vehicle prior to step (2).

5. The method of claim 4, wherein steps (2) and (3) are performed on a computer network.

6. The method of claim 5, wherein the computer database of step (1) is maintained on a global computer communications network.

7. The method of claim 2, wherein step (1) comprises entering the status data on the vehicle status into a data transfer device and transferring the status data from the data transfer device to the computer database.

8. The method of claim 7, wherein the device is portable.

9. The method of claim 2, wherein the computer database stores an identifier for the vehicle and step (2) comprises searching for the identifier of the vehicle.

10. The method of claim 9, wherein the identifier is a repair order number, a Vehicle Identification Number, or a bar code.

11. The method of claim 1, wherein the status data includes information selected from the group consisting of: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed.

12. The method of claim 11, wherein the vehicle undergoes repair steps which result in the status data of claim 11.

13. The method of claim 12, wherein said repair steps are performed in the order of the information of (i)-(xx) of claim 11.

14. The method of claim 12, wherein the status of the vehicle is provided to the owner of the vehicle following at least one of repair steps (v), (x), (xv), and (xx).

15. The method of claim 14, wherein the status of the vehicle is automatically provided to the owner of the vehicle.

16. A method of tracking the repair process of a vehicle that is in a repair shop comprising the steps of:
(1) periodically electronically transferring data on the status of a plurality of vehicles undergoing repair to a database on a computer;
(2) determining the length of time that the status data for each vehicle remains unchanged via software on the computer; and
(3) identifying a vehicle for which the status data is unchanged beyond a predetermined length of time and identifying the unchanged status data.

17. The method of claim 16, wherein the status data of step (1) is transferred daily.

18. The method of claim 16, wherein the status data of step (1) is selected from the group consisting of: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed.

19. The method of claim 16, wherein step (1) comprises entering the status data into a data transfer device and transferring the data from the data transfer device to a computer.

20. The method of claim 16, wherein the database stores an identifier for each vehicle, the identifier being selected from the group consisting of vehicle make, vehicle model and vehicle year such that the software determines the extent that the status data for each identifier remains unchanged beyond a predetermined length of time.

21. A system for determining the status of an article on which work is being performed comprising:
a data transfer device for entering data on the status of an article on which work is being performed;
a computer database for tabulating data entered in the data transfer device and transferred to said computer database;
software for identifying an article in said database and the corresponding data on the status of the article; and
means for transferring the corresponding data to a remote location.

22. The system of claim 21, wherein said data transfer device is portable.

23. The system of claim 21, wherein the article is a vehicle undergoing repair.

24. The system of claim 23, wherein said status data includes information selected from the group consisting of: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed.

25. The system of claim 24, wherein the status data includes a vehicle identifier.

26. The system of claim 25, wherein the identifier is a repair order number, a Vehicle Identification Number, or a bar code.

27. The system of claim 21, wherein said means for transferring the corresponding data is a computer network.

28. A system of determining the status of an article on which work is being performed comprising:
(1) means for electronically transferring data on the status of an article to a computer database;
(2) means for searching the computer database to locate the article; and
(3) means for identifying the data on the status of the article.

29. The system of claim 28, wherein the article is a vehicle undergoing repair.

30. The system of claim 29, wherein means (3) further comprises means for electronically transferring the identified data to a remote location.

31. The system of claim 30 further comprising (4) means for electronically requesting the status of the vehicle.

32. The system of claim 31 further comprising a computer network having means (2), (3), and (4).

33. The system of claim 29, wherein the second database stores an identifier for the vehicle and means (2) comprises a means for searching for the identifier of the vehicle.

34. The system of claim 33, wherein the identifier is a repair order number, a Vehicle Identification Number, or a bar code.

35. The system of claim 29, wherein means (1) further comprises means for electronically transferring the data from a remote location to the computer database.

36. The system of claim 35, wherein means (1) comprises a data transfer device into which the data on the vehicle status has been entered.

37. The system of claim 36, wherein said data transfer device is portable.

38. The system of claim 29, wherein the status data includes information selected from the group consisting of: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed.

39. The system of claim 38, wherein the vehicle undergoes repair steps which result in the status data of claim 38.

40. The system of claim 39, wherein the repair steps are performed in the order of the information of (i)-(xx) of claim 38.

41. The system of claim 39 in which means (3) comprises a means for the owner of the vehicle to access the database to determine the status of the vehicle following at least one of repair steps (v), (x), (xv), and (xx).

42. The system of claim 41, wherein the means for accessing the status of the vehicle is automatically employed.

43. A system of tracking the repair process of a vehicle that is in a repair shop comprising:
(1) means for electronically transferring data on a periodic basis on the status of a plurality of vehicles undergoing repair to a database of a computer;
(2) means for determining the length of time that the status data for each vehicle remains unchanged via software on the computer; and
(3) means for identifying a vehicle for which the status data is unchanged beyond a predetermined length of time and identifying the unchanged status data.

44. The system of claim 43, wherein the status data is transferred daily.

45. The system of claim 43, wherein the status data of step (1) is selected from the group consisting of: (i) cost estimate completed, (ii) repair authorized by owner, (iii) insurance approved, (iv) parts ordered, (v) parts received, (vi) vehicle scheduled for repair, (vii) vehicle disassembled, (viii) supplemental damage report written, (ix) repair of supplemental damage approved by insurance, (x) additional parts ordered, (xi) vehicle set up on repair equipment, (xii) structure and body repaired, (xiii) panels installed, (xiv) corrosion protection applied, (xv) metal work completed, (xvi) vehicle primed for painting, (xvii) vehicle painted, (xviii) vehicle cleaned, (xix) vehicle refinished, and (xx) repair completed.

46. The system of claim 43, wherein means (1) is a portable data transfer device into which status data is entered and transferred to the database.

47. The system of claim 43, wherein the database stores an identifier for each vehicle, the identifier being selected from the group consisting of vehicle make, vehicle model, and vehicle year such that the software determines the extent that the status data for each identifier remains unchanged beyond a predetermined length of time.
